(19) United States
(12) Patent Application Publication
(10) Pub. No.: US 2024/0210570 A1
(43) Pub. Date: Jun. 27, 2024

(54) Method And Apparatus For Global Navigation Satellite System Operations

(71) Applicant: MediaTek Singapore Pte. Ltd., Singapore (SG)

(72) Inventors: Yao-Hua Cai, Beijing (CN); Wen Tang, Beijing (CN); Hsuan-Li Lin, Hsinchu City (TW); Gilles Charbit, Cambridge (GB); Abhishek Roy, San Jose, CA (US)

(21) Appl. No.: 18/393,481

(22) Filed: Dec. 21, 2023

(30) Foreign Application Priority Data
Dec. 22, 2022 (WO) PCT/CN2022/141018
Feb. 23, 2023 (WO) PCT/CN2023/077875
Dec. 18, 2023 (CN) 202311744209.4

(51) Int. Cl. G01S 19/39; G01S 19/23

(52) U.S. Cl. CPC G01S 19/396; G01S 19/23

(57) ABSTRACT

Various solutions for global navigation satellite system (GNSS) operations with respect to user equipment and network node in mobile communications are described. An apparatus may transmit a GNSS position fix time duration and a GNSS validity duration to a network node during an initial access. The apparatus may receive a configuration based on the GNSS position fix time duration and the GNSS validity duration from the network node in a connected mode. The apparatus may perform a GNSS measurement based on the configuration. The apparatus may transmit a new GNSS validity duration to the network node in the connected mode in an event that the apparatus completes the GNSS measurement.

### CROSS REFERENCE TO RELATED PATENT APPLICATION(S)

The present disclosure is part of a non-provisional application claiming the priority benefit of China Patent Application No. 202311744209.4, filed 18 Dec. 2023 and claiming the priority benefit of PCT Application No. PCT/CN2022/141018, filed 22 Dec. 2022, and PCT Application No. PCT/CN2023/077875, filed 23 Feb. 2023. Contents of the aforementioned applications are herein being incorporated by reference in their entirety.

### TECHNICAL FIELD

The present disclosure is generally related to mobile communications and, more particularly, to global navigation satellite system (GNSS) operations with respect to user equipment (UE) and network apparatus in mobile communications.

### BACKGROUND

Unless otherwise indicated herein, approaches described in this section are not prior art to the claims listed below and are not admitted as prior art by inclusion in this section.

The wireless communications network has grown exponentially over the years. A long-term evolution (LTE) system offers high peak data rates, low latency, improved system capacity, and low operating cost resulting from simplified network architecture. LTE systems, also known as the 4G system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3rd generation partner project (3GPP) network normally includes a hybrid of 2G/3G/4G systems. The next generation mobile network (NGMN) board has decided to focus the future NGMN activities on defining the end-to-end requirements for 5G new radio (NR) systems and 6G systems.

In conventional communication technology, narrowband internet of things (NB-IOT) and enhanced machine type communication (eMTC) are specified for the purpose of providing a new access system with low complexity and low throughput. The IoT operations may be performed in the remote areas with lower or no cellular connectivity for many different industries. NB-IOT and eMTC operations for Non-Terrestrial Networks (NTN) also have been specified.

Because of the long propagation delay between UE and satellite, in order to achieve synchronization with a cell, the UE may autonomously pre-compensate the timing advance (TA) and the frequency doppler shift by considering the common TA, the UE position, and the satellite position through the satellite ephemeris. The global navigation satellite system (GNSS) capability of UE may be regarded as a working assumption for both NB-IOT and eMTC devices. For the working assumption, the UE may estimate and pre-compensate timing and frequency offsets to achieve sufficient accuracy for uplink (UL) transmission. In addition, the GNSS operations and NTN NB-IoT/eMTC operations cannot be performed simultaneously.

In conventional communication technology, for sporadic and short transmission, the UE may need to acquire the GNSS position before the connection with the network node is established and report the GNSS validity duration to the network node through the Message 5 (Msg5). In the connected mode, when the GNSS position is outdated, the UE may need to move to the idle mode.

However, in conventional communication technology, for long connection, the GNSS operations and NTN NB-IOT/eMTC operations also cannot be performed simultaneously. Therefore, the UE may need to re-acquire the GNSS position fix time duration during the connected mode.

Accordingly, how to perform the GNSS operations becomes an important issue for the newly developed wireless communication network. Therefore, there is a need to provide proper schemes and designs for the GNSS operations.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to global navigation satellite system (GNSS) operations. It is believed that the above-described issue would be avoided or otherwise alleviated by implementing one or more of the proposed schemes described herein.

In one aspect, a method may involve an apparatus transmitting a global navigation satellite system (GNSS) position fix time duration and a GNSS validity duration to a network node during the initial access. The method may also involve the apparatus receiving a configuration based on the GNSS position fix time duration and the GNSS validity duration from the network node in a connected mode. The method may also involve the apparatus performing a GNSS measurement based on the configuration. The method may further involve the apparatus transmitting a new GNSS validity duration to the network node in the connected mode in an event that the apparatus completes the GNSS measurement.

In another aspect, an apparatus may involve a transceiver which, during operation, wirelessly communicates with at least one network node. The apparatus may also involve a processor communicatively coupled to the transceiver such that, during operation. The processor may transmit, via the transceiver, a GNSS position fix time duration and a GNSS validity duration to a network node during the initial access. The processor may also receive, via the transceiver, a configuration based on the GNSS position fix time duration and the GNSS validity duration from the network node in a connected mode. The processor may also perform a GNSS measurement based on the configuration. The processor may further transmit, via the transceiver, a new GNSS validity duration to the network node in the connected mode in an event that the apparatus completes the GNSS measurement.

In another aspect, a method may involve a network node receiving a GNSS position fix time duration and a GNSS validity duration from a user equipment (UE) during the initial access. The method may also involve the network node transmitting a configuration based on the GNSS position fix time duration and the GNSS validity duration to the UE in a connected mode. The method may further involve the network node receiving a new GNSS validity duration from the UE in the connected mode.

It is noteworthy that, although description provided herein may be in the context of certain radio access technologies, networks and network topologies such as 5^{th} Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IOT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of global navigation satellite system (GNSS) operations under schemes in accordance with implementations of the present disclosure.

FIG. 2 is a diagram depicting another example scenario of GNSS operations under schemes in accordance with implementations of the present disclosure.

FIG. 3 is a diagram depicting another example scenario of GNSS operations under schemes in accordance with implementations of the present disclosure.

FIG. 4 is a diagram depicting an example scenario of timer T31x under schemes in accordance with implementations of the present disclosure.

FIG. 5 is a diagram depicting another example scenario of timer T31x under schemes in accordance with implementations of the present disclosure.

FIG. 6 is a block diagram of an example communication system in accordance with an implementation of the present disclosure.

FIG. 7 is a flowchart of an example process in accordance with an implementation of the present disclosure.

FIG. 8 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to global navigation satellite system (GNSS) operations. According to the present disclosure, a number of possible solutions may be implemented separately or jointly. That is, although these possible solutions may be described below separately, two or more of these possible solutions may be implemented in one combination or another.

In accordance with implementations of the present disclosure, a user equipment (UE) may transmit a GNSS position fix time duration and a GNSS validity duration to a network node during the initial access. Then, the network node may generate or determine the configuration based on the GNSS position fix time duration and the GNSS validity duration from the UE, and transmit the configuration to the UE in a connected mode. After the UE receives the configuration based on the GNSS position fix time duration and the GNSS validity duration from the network node in the connected mode, the UE may perform a GNSS measurement based on the configuration. When the UE completes the GNSS measurement, the UE may transmit a new GNSS validity duration to the network node in the connected mode.

In an example, the UE may obtain the GNSS position fix time duration during the initial access. The GNSS position fix time duration may indicate how long the UE would need for obtaining the GNSS position information, e.g., GNSS position fix.

In order to affiliate the acquisition of GNSS position fix in connected mode, the network node may need to be informed how long the UE takes to perform the GNSS measurement. According to the information (e.g., the GNSS position fix time duration and the GNSS validity duration) from the UE, the network can estimate the time when the UE will finish the GNSS measurement. Therefore, if the UE is failed to get GNSS position fix (e.g., due to loss of GNSS coverage), and then failed to inform network node the success of acquisition, the network node can know that the UE leaves connected mode and the network node may keep the state for the UE.

In some implementations, the UE may transmit the GNSS position fix time duration and the GNSS validity duration in the process of connection establishment, connection resume or connection re-establishment. In an example, the UE may transmit the GNSS position fix time duration and the GNSS validity duration through a radio resource control (RRC) signaling in Message (Msg3) (e.g., RRCConnectionRequest, RRCConnectionResumeRequest, RRCConnectionReestablishmentRequest, RRCConnection ReestablishmentComplete or RRCConnectionReestablishmentComplete-NB) or Message 5 (Msg5) (e.g., RRCConnectionSetupComplete, RRCConnectionSetupComplete-NB, RRCConnectionResumeComplete, RRCConnectionResumeComplete-NB, RRCConnectionReestablishmentComplete, or RRCConnection ReconfigurationComplete). In another example, the UE may transmit the GNSS position fix time duration and the GNSS validity duration through a new MAC CE carried in the Msg3 or Msg5.

In an implementation, if the network node knows the success of acquisition of GNSS measurement after a random access procedure, the information from the UE may not only comprise the time taken by GNSS measurement, but also comprise the time taken by downlink (DL) synchronization and random access procedure. For example, for the GNSS Position Time To First Fix (TTFF), hot start will be 1 second (s) or 2 s, warm start will be several seconds, cold start will be 30 s. The information may use enumeration value in a range of 1 s to 30 s.

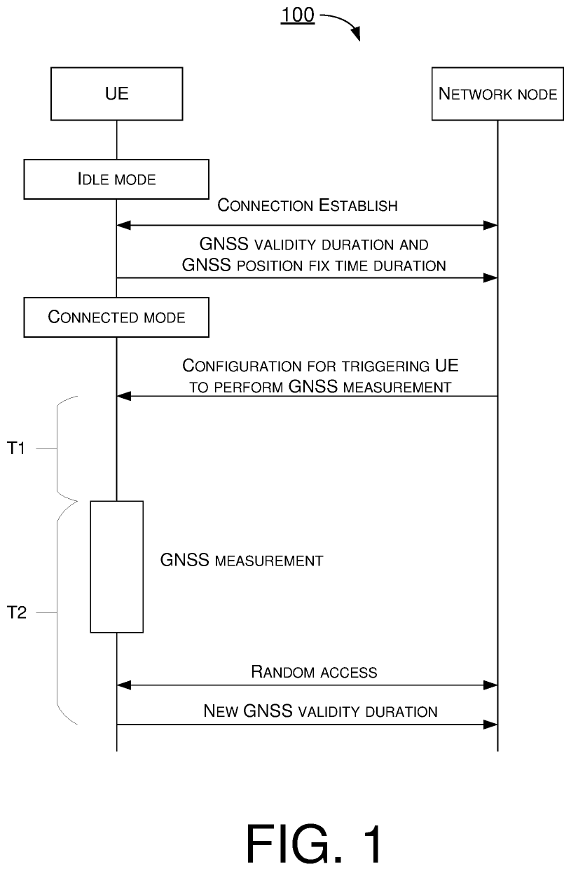

In some implementations, the configuration from the network node may comprise a first time duration and a second time duration. The first time duration may indicate a start time of the GNSS measurement, and the second time duration may indicate a measurement gap length for performing the GNSS measurement. That is, in the implementations, in connected mode, after the UE has reported the GNSS position fix time duration and the GNSS validity duration to the network node, the network node may trigger the UE to perform the GNSS measurement by transmitting the configuration to the UE. FIG. 1 is an example for illustrating the implementations below.

FIG. 1 illustrates an example scenario 100 for GNSS operations under schemes in accordance with implementations of the present disclosure. Scenario 100 involves a network node (e.g., a macro base station and a micro base station) and a UE, which may be a part of a wireless communication network (e.g., an LTE network, a 5G/NR network, an IoT network or a 6G network). Referring to FIG. 1, during the initial access, the UE may transmit the GNSS position fix time duration and the GNSS validity duration to the network node. In the connected mode, the network node may transmit the configuration to the UE through a layer 1 (L1) signaling downlink control information (DCI), an RRC signaling (e.g., RRCConnectionReconfiguration), or a new medium access control control-element (MAC CE) based on the GNSS position fix time duration and the GNSS validity duration to trigger the UE to perform the GNSS measurement. Then, the UE may perform GNSS measurement based on the configuration from the network node. In addition, the UE and the network node may perform the random access. After the UE completes the GNSS measurement, the UE may transmit a new GNSS validity duration to the network node.

In the configuration from the network node, the network node may configure a start time of starting the GNSS measurement. Referring to FIG. 1, the start time of the GNSS measurement may be denoted as T1 (i.e., first time duration). During T1, the network node may assume that the UE can still maintain the timing and frequency synchronization, even after the end of the GNSS validity duration. Because T1 is configured in the configuration, the duration of the GNSS measurements can be prolonged. Therefore, the power consumption of the UE can be saved. The network node may estimate the value of T1 via timing errors and frequency errors which are detected by the network node. In an example, the value of T1 can be configured as an exact absolute time, or as a differential value relative to the end of GNSS validity. If T1 is absent or configured as 0, the UE may start GNSS measurement immediately when the UE receives the configuration from the network node, or the UE may start GNSS measurement immediately after the hybrid automatic repeat request (HARQ) acknowledgement (ACK) transmission/radio link control (RLC) status protocol data unit (PDU) transmission followed the configuration from the network node. In another example, T1 can use enumeration. In another example, T1 can be configured as system frame numbers or seconds/milliseconds.

In addition, in an example, in the configuration, the network node may configure a time duration to the UE. In the time duration, the GNSS measurement should be done. In another example, in the configuration, the network node may specify the exact time in system frame numbers or seconds/milliseconds when the GNSS measurement is expected to be done. Referring to FIG. 1, the configured time for performing the GNSS measurement can be denoted as T2 (i.e., second time duration). If the GNSS position duration time reported by UE comprises the time taken by UE for the random access procedure, T2 may be configured as same as the reported value. Otherwise, T2 may be configured as a value slightly larger than GNSS position fix duration time reported by UE plus the time needed for random access. If T2 is not configured by network node, the UE may use the value of GNSS position fix duration time which is reported to network node.

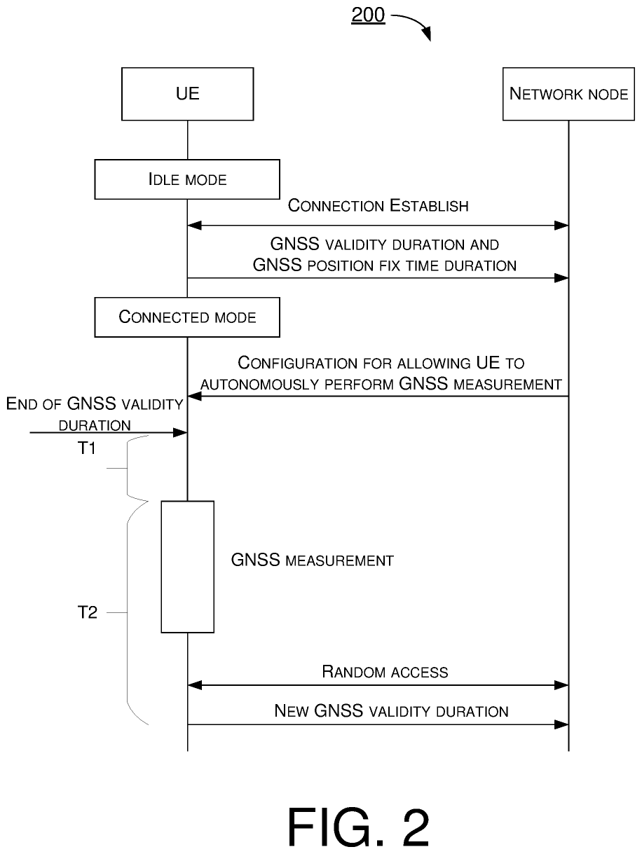

In some implementations, the configuration from the network node may comprise a first time duration and a second time duration. The first time duration may indicate a start time of the GNSS measurement after an end of the GNSS validity duration, and the second time duration may indicate a measurement gap length for performing the GNSS measurement. That is, in the implementations, in connected mode, after the UE has reported the GNSS position fix time duration and the GNSS validity duration to the network node, the network node may transmit the configuration to the UE to allow the UE to autonomously perform the GNSS measurement according to the configuration. FIG. 2 is an example for illustrating the implementations below.

FIG. 2 illustrates another example scenario 200 for GNSS operations under schemes in accordance with implementations of the present disclosure. Scenario 200 involves a network node (e.g., a macro base station and a micro base station) and a UE, which may be a part of a wireless communication network (e.g., an LTE network, a 5G/NR network, an IoT network or a 6G network). Referring to FIG. 2, during the initial access, the UE may transmit the GNSS position fix time duration and the GNSS validity duration to the network node. In the connected mode, the network node may transmit the configuration to the UE through an L1 signaling DCI, an RRC signaling (e.g., RRCConnectionReconfiguration), or a new MAC CE based on the GNSS position fix time duration and the GNSS validity duration to allow the UE to autonomously perform the GNSS measurement according to the configuration after the end of GNSS validity duration. Then, the UE may perform GNSS measurement based on the configuration from the network node. In addition, the UE and the network node may perform the random access. After UE completes the GNSS measurement, the UE may transmit a new GNSS validity duration to the network node.

In the configuration from the network node, the network node may configure a start time of the GNSS measurement after the end of the GNSS validity duration. Referring to FIG. 2, the start time may be denoted as T1 (i.e., first time duration). During T1, the network node may assume that the UE can still maintain the timing and frequency synchronization, even after the end of the GNSS validity duration. Because T1 is configured in the configuration, the duration of the GNSS measurements can be prolonged. Therefore, the power consumption of the UE can be saved. The network node may estimate the value of T1 via the GNSS position fix time duration reported by the UE, and the timing errors and frequency errors which are detected by the network node. In an example, the value of T1 can be configured as a differential value relative to the end of GNSS validity. If T1 is not configured or configured as 0, the UE may start GNSS measurement at the end of GNSS validity time. In another example, T1 can use enumeration. In another example, T1 can be configured as system frame numbers or seconds/milliseconds.

In addition, in an example, in the configuration, the network node may configure a time duration to the UE. In the time duration, the GNSS measurement should be done. In another example, in the configuration, the network node may specify the exact time in system frame numbers or seconds/milliseconds when the GNSS measurement is expected to be done. Referring to FIG. 2, configured time for performing the GNSS measurement can be denoted as T2 (i.e., second time duration). If the GNSS position duration time reported by UE comprises the time taken by UE for the random access procedure, T2 may be configured as same as the reported value. Otherwise, T2 may be configured as a value slightly larger than GNSS position fix duration time reported by UE plus the time needed for random access. If T2 is not configured by network node, the UE may use the value of GNSS position fix duration time which is reported to network node.

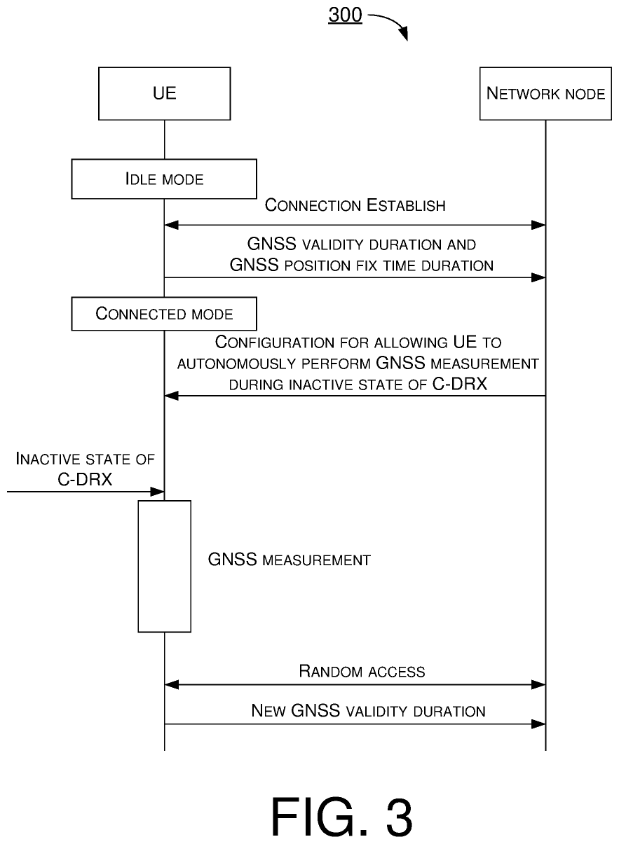

In some implementations, the configuration from the network node may comprise a connected-mode discontinuous-reception (C-DRX). The UE may perform GNSS measurement autonomously during an inactive state (or inactive time) of the C-DRX. That is, in the implementations, in connected mode, after the UE has reported the GNSS position fix time duration and the GNSS validity duration to the network node, the network node may transmit the configuration to the UE to allow the UE to autonomously perform the GNSS measurement according to the configuration during an inactive state of the C-DRX. FIG. 3 is an example for illustrating the implementations below.

FIG. 3 illustrates another example scenario 300 for GNSS operations under schemes in accordance with implementations of the present disclosure. Scenario 300 involves a network node (e.g., a macro base station and a micro base station) and a UE, which may be a part of a wireless communication network (e.g., an LTE network, a 5G/NR network, an IoT network or a 6G network). Referring to FIG. 3, during the initial access, the UE may transmit the GNSS position fix time duration and the GNSS validity duration to the network node. In the connected mode, the network node may transmit the configuration to the UE through an L1 signaling DCI, an RRC signaling (e.g., RRCConnectionReconfiguration), or a new MAC CE based on the GNSS position fix time duration and the GNSS validity duration to allow the UE to autonomously perform the GNSS measurement according to the configuration during an inactive state of the C-DRX. Then, the UE may perform GNSS measurement based on the configuration from the network node. In addition, the UE and the network node may perform the random access. After the UE completes the GNSS measurement, the UE may transmit a new GNSS validity duration to the network node.

The UE can perform GNSS measurement if the UE can find an inactive time period of C-DRX that is longer than the GNSS position fix time duration before the end of the GNSS validity duration. When the GNSS measurement is started too early, more power consumption will be needed. When the GNSS measurement is started later, the suitable inactive time can be occupied. When to start the GNSS measurement can be based on the UE implementation.

In some implementations, the UE may suspend at least one of a timer and a counter for radio link monitoring when the UE is performing the GNSS measurement. When the UE is performing the GNSS measurement, the least time may be 2 seconds. Therefore, it is assumed that DL and UL synchronization will be lost. The UE may be not able to receive any DL data or transmit any UL data when the UE is performing the GNSS measurement. For the case of network node triggered GNSS measurement, the network node may configure the time when the UE needs to perform the GNSS measurement, so that the network node can buffer DL data and stop sending UL grant. For the case of UE autonomous GNSS measurement after the end of the GNSS validity duration, the network node may know the time when the UE starts to perform the GNSS measurement based on the GNSS validity duration reported by the UE, so that the network node can also buffer DL data and stop send UL grant. For the case of UE autonomous GNSS measurement during the inactive state of C-DRX, the network node will not transmit physical downlink control channel (PDCCH) during the inactive state of C-DRX in the first place. Since the UE does not have the UL synchronization, the UE may stop the timing alignment timer (TAT) accordingly. The random access should also be prevented during this time. In addition, it is possible that UE may not receive DL signal during the period of performing the GNSS measurement. Therefore, the counters and timers related to radio link failure procedure may all be reset to prevent possible radio link failure.

In some implementations, the new GNSS validity duration may be transmitted through a MAC CE (e.g., an UL MAC CE). When the UE complete the GNSS measurement, UE may transmit or report the new GNSS validity duration to the network node again in the RRC connected mode through a new MAC CE. In an example, the new GNSS validity duration reported in the connected mode can have the same candidate value as the GNSS validity duration reported in the initial access. In another example, the new GNSS validity duration may be differential value relative to the one reported in the initial access. A value range {10 seconds (10 s), 20 s, 30 s, 40 s, 50 s, 60 s, 5 minutes (min), 10 min, 15 min, 20 min, 25 min, 30 min, 60 min, 90 min, 120 min, infinity} may be used for the new GNSS validity duration report. Because during the GNSS measurement, the UE loses the DL synchronization and the UL synchronization, the UE should synchronize the DL timing first. After the UE complete the GNSS measurement, the UE may need to send a Schedule Request (SR) to trigger random access procedure to obtain timing alignment. The time alignment timer (TAT) will be started after the successful random access. The configurations of the GNSS measurement can be cancelled or kept.

In some implementations, the UE may enter the initial access or trigger a radio link failure when the UE is not able to transmit the new GNSS validity duration to the network node successfully. For example, if the UE cannot report the new GNSS validity duration before the T2, the UE may move into the initial access or trigger a radio link failure directly. In an example, the UE cannot report the new GNSS validity duration because the UE cannot get the GNSS position fix before the end of T2 or inactive time of the C-DRX due to a lack of GNSS coverage. In another example, the UE cannot report the new GNSS validity duration because the random access to report the new GNSS validity duration in connected mode is not successful.

In some implementations, the configurations from the network node for triggering GNSS measurement (e.g., the UE autonomously performing GNSS measurement after the end of GNSS validity duration, and the UE autonomously performing GNSS measurement in inactive state of the C-DRX) may be configured to UE in a same configuration or different configurations. The UE may perform GNSS measurement at the time which is earlier in the configurations.

In some implementations, the network node may transmit an UL grant to the UE after the GNSS measurement. After the UE receives the UL grant from the network node, the UE may report a new GNSS validity duration to the network node through the resources indicated in the UL grant (e.g., a physical uplink shared channel (PUSCH)).

In some implementations, the UE may stop the RRC timer T317 during the GNSS measurement (e.g., during the gap or timing configured by the network node for the UE to re-acquire the GNSS measurement). For example, if the timer T317 expires during the GNSS measurement, the UE may not start the timer T318 and the re-acquisition of the SIB31 until the GNSS measurement has been completed. In another example, if the timer T317 expires during the GNSS measurement, the UE may start the timer T318 and the re-acquisition of the SIB31 after the end of GNSS measurement. In another example, if the timer T317 does not expire during the GNSS measurement, the UE may start the timer T318 and the re-acquisition of the SIB31 at the expiration of the timer T317. In addition, in an example, if the timer T317 does not expire in an inactive mode of the C-DRX of the GNSS measurement, the UE may start the timer T318 to re-acquire the SIB31 at the expiration of the timer T317. In another example, if the timer T317 expires in the inactive mode of the C-DRX of the GNSS measurement, the UE may start the timer T318 and re-acquire the SIB31 after the end of GNSS measurement.

In some implementations, a UE timer T31X may be introduced to wait for the UL grant. The timer T31X may be configured to the UE by the network node. The UE may start the T31X after the GNSS measurement.

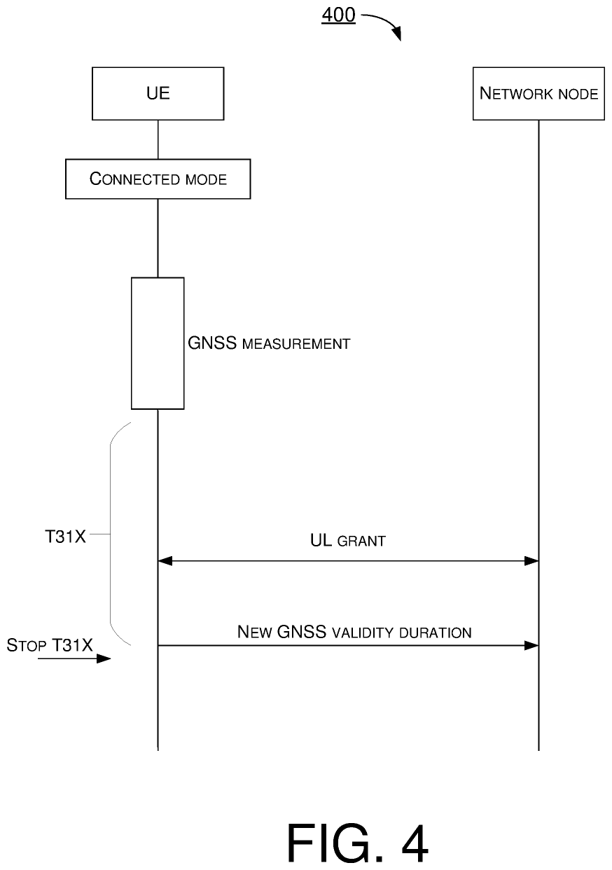

FIG. 4 illustrates an example scenario 400 for timer T31x under schemes in accordance with implementations of the present disclosure. Scenario 400 involves a network node (e.g., a macro base station and a micro base station) and a UE, which may be a part of a wireless communication network (e.g., an LTE network, a 5G/NR network, an IoT network or a 6G network). Referring to FIG. 4, the UE may trigger a scheduling request (SR) (e.g., trigger a random access) to report the new GNSS validity duration after the expiration of the timer T31X. The new GNSS validity duration may be different from the last reported value. The UE may stop the timer T31X when the UE receives the UL grant. For example, after the expiration of the timer T31X, the GNSS validity duration report can be combined with the UL user data if available.

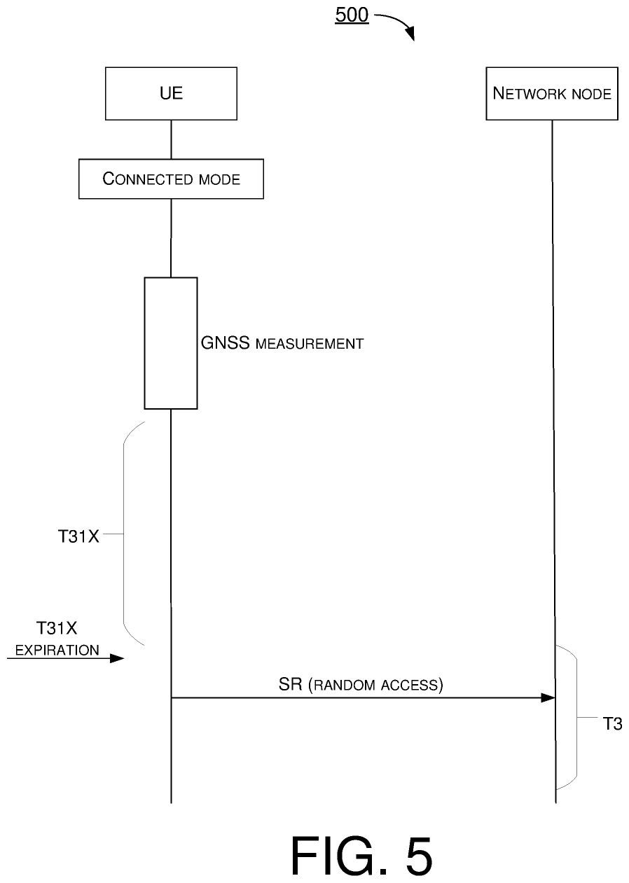

FIG. 5 illustrates another example scenario 500 for timer T31X under schemes in accordance with implementations of the present disclosure. Scenario 500 involves a network node (e.g., a macro base station and a micro base station) and a UE, which may be a part of a wireless communication network (e.g., an LTE network, a 5G/NR network, an IoT network or a 6G network). Referring to FIG. 5, the UE may not need to send the new GNSS validity duration after the expiration of T31X. In some implementations, the network node may wait for a dedicated time duration T3 to indicate whether the UE has the same GNSS validity duration after the expiration of the timer T31X. For example, if the network node does not receive the SR from the UE before the dedicated time duration T3, the network node may determine that the UE has the same GNSS validity duration as the last reported value or first reported value in Msg5 during the initial access. The dedicated time duration T3 may be a time duration for network implementation. In an example, if the UE determines not to report the new GNSS validity duration, the network node may not be able to differentiate between that the UE uses same GNSS validity duration and that the UE failed to obtain the GNSS position fix.

In some implementations, when UE autonomously perform the GNSS measurement in the inactive time of the C-DRX, the UE may send SR to report the new GNSS validity duration. The SR after the GNSS measurement may be send through a random access channel (RACH) for the NB-IOT or eMTC.

In some implementations, before the first UL grant which is sent after GNSS measurement without RACH, the UE (e.g., an IoT NTN UE or an NR NTN UE) may set a timing advance value (e.g., N_TA) to zero for a narrowband physical uplink shared channel (NPUSCH), a physical uplink control channel (PUCCH), or a PUSCH. After the UE's SIB acquisition (e.g., the re-acquisition of the SIB31) in the connected mode, the IoT NTN UE or the NR NTN UE may set the timing advance value (e.g., N_TA) to zero for the NPUSCH/PUCCH/PUSCH, and the NR NTN UE may reset the sounding reference signal (SRS).

### Illustrative Implementations

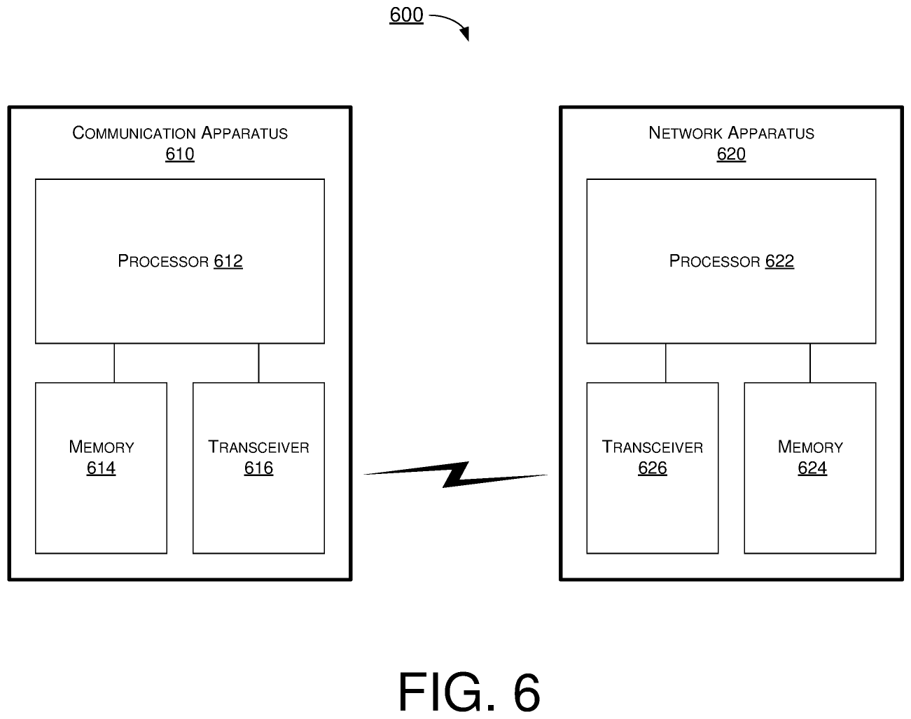

FIG. 6 illustrates an example communication system 600 having at least an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to perform GNSS operations in mobile communications, including the various schemes described above with respect to various proposed designs, concepts, schemes and methods described above and with respect to user equipment and network apparatus in mobile communications, including scenarios/schemes described above as well as process 700 and process 800 described below

Communication apparatus 610 may be a part of an electronic apparatus, which may be a UE such as a portable or mobile apparatus, a wearable apparatus, a wireless communication apparatus or a computing apparatus. For instance, communication apparatus 610 may be implemented in a smartphone, a smartwatch, a personal digital assistant, a digital camera, or a computing equipment such as a tablet computer, a laptop computer or a notebook computer. Communication apparatus 610 may also be a part of a machine type apparatus, which may be an IoT, NB-IOT, or IIoT apparatus such as an immobile or a stationary apparatus, a home apparatus, a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6 such as a processor 612, for example. Communication apparatus 610 may further include one or more other components not pertinent to the proposed scheme of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of a network apparatus, which may be a network node such as a satellite, a base station, a small cell, a router or a gateway. For instance, network apparatus 620 may be implemented in an eNodeB in an LTE network, in a gNB in a 5G/NR, IoT, NB-IOT or IIoT network or in a satellite or base station in a 6G network. Alternatively, network apparatus 620 may be implemented in the form of one or more IC chips such as, for example and without limitation, one or more single-core processors, one or more multi-core processors, or one or more RISC or CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including performing GNSS operations in a device (e.g., as represented by communication apparatus 610) and a network (e.g., as represented by network apparatus 620) in accordance with various implementations of the present disclosure.

In some implementations, communication apparatus 610 may also include a transceiver 616 coupled to processor 612 and capable of wirelessly transmitting and receiving data. In some implementations, communication apparatus 610 may further include a memory 614 coupled to processor 612 and capable of being accessed by processor 612 and storing data therein. In some implementations, network apparatus 620 may also include a transceiver 626 coupled to processor 622 and capable of wirelessly transmitting and receiving data. In some implementations, network apparatus 620 may further include a memory 624 coupled to processor 622 and capable of being accessed by processor 622 and storing data therein. Accordingly, communication apparatus 610 and network apparatus 620 may wirelessly communicate with each other via transceiver 616 and transceiver 626, respectively. To aid better understanding, the following description of the operations, functionalities and capabilities of each of communication apparatus 610 and network apparatus 620 is provided in the context of a mobile communication environment in which communication apparatus 610 is implemented in or as a communication apparatus or a UE and network apparatus 620 is implemented in or as a network node of a communication network.

In some implementations, processor 612 may transmit, via transceiver 616, a GNSS position fix time duration and a GNSS validity duration to network apparatus 620 during the initial access. Processor 612 may receive, via transceiver 616, a configuration based on the GNSS position fix time duration and the GNSS validity duration from network apparatus 620 in a connected mode. Processor 612 may perform a GNSS measurement based on the configuration. Processor 612 may transmit, via transceiver 616, a new GNSS validity duration to network apparatus 620 in the connected mode in an event that the UE completes the GNSS measurement.

In some implementations, the GNSS position fix time duration and the GNSS validity duration may be transmitted through an Msg5 message or an Msg3 message.

In some implementations, the configuration may comprise a first time duration and a second time duration, wherein the first time duration may indicate a start time of the GNSS measurement, and the second time duration may indicate a measurement gap length for performing the GNSS measurement.

In some implementations, the configuration may comprise a first time duration and a second time duration, wherein the first time duration may indicate a start time of the GNSS measurement after an end of the GNSS validity duration, and the second time duration may indicate a measurement gap length for performing the GNSS measurement.

In some implementations, the configuration may comprise a C-DRX, wherein the GNSS measurement is autonomously performed during an inactive state of the C-DRX.

In some implementations, processor 612 may suspend at least one of a timer and a counter for radio link monitoring in an event that the UE is performing the GNSS measurement.

In some implementations, the new GNSS validity duration may be transmitted through a MAC CE.

In some implementations, processor 612 may enter the initial access or trigger a radio link failure in an event that communication apparatus 610 is not able to transmit the new GNSS validity duration to the network node successfully.

In some implementations, processor 612 may receive an UL grant from the network apparatus 620. Processor 612 may further transmit the new GNSS validity duration through resources indicated in the UL grant.

In some implementations, before a first UL grant which is transmitted after the GNSS measurement without a RACH, processor 612 may set a timing advance value (e.g., N_TA) to zero for an NPUSCH, a PUCCH, or a PUSCH. After a SIB acquisition in the connected mode, the processor 612 may further set the timing advance value (e.g., N_TA) to zero for the NPUSCH, PUCCH, or PUSCH, and resetting an SRS.

In some implementations, in an event that a timer T317 expires during the GNSS measurement, processor 612 may not start a timer T318 and a re-acquisition of a SIB31 until the GNSS measurement has been completed. In an event that the timer T317 does not expire during the GNSS measurement, processor 612 may further start the timer T318 and the re-acquisition of the SIB31 after an expiration the timer T317.

In some implementations, processor 622 may receive, via transceiver 626, a GNSS position fix time duration and a GNSS validity duration from communication apparatus 610 during the initial access. Processor 622 may transmit, via transceiver 626, a configuration based on the GNSS position fix time duration and the GNSS validity duration to communication apparatus 610 in a connected mode. Processor 622 may receive, via transceiver 626, a new GNSS validity duration from the communication apparatus 610 in the connected mod.

In some implementations, the configuration may comprise a first time duration and a second time duration, wherein the first time duration may indicate a start time of the GNSS measurement, and the second time duration may indicate a measurement gap length for performing the GNSS measurement.

In some implementations, the configuration may comprise a first time duration and a second time duration, wherein the first time duration may indicate a start time of the GNSS measurement after an end of the GNSS validity duration, and the second time duration may indicate a measurement gap length for performing the GNSS measurement.

In some implementations, the new GNSS validity duration may be received through a MAC CE.

### Illustrative Processes

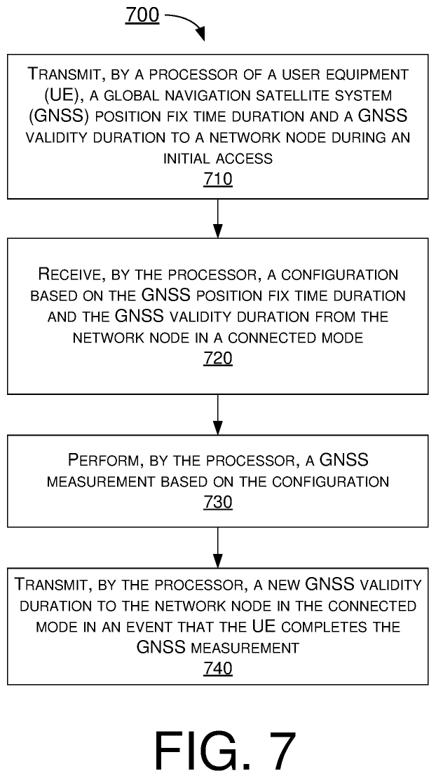

FIG. 7 illustrates an example process 700 in accordance with an implementation of the present disclosure. Process 700 may be an example implementation of above scenarios/schemes, whether partially or completely, with respect to the GNSS operations with the present disclosure. Process 700 may represent an aspect of implementation of features of communication apparatus 610. Process 700 may include one or more operations, actions, or functions as illustrated by one or more of blocks 710, 720, 730 and 740. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by communication apparatus 610 or any suitable UE or machine type devices. Solely for illustrative purposes and without limitation, process 700 is described below in the context of communication apparatus 610. Process 700 may begin at block 710.

At 710, process 700 may involve processor 612 of communication apparatus 610 transmitting, via transceiver 616, a GNSS position fix time duration and a GNSS validity duration to a network node during the initial access. Process 700 may proceed from 710 to 720.

At 720, process 700 may involve processor 612 receiving, via transceiver 616, a configuration based on the GNSS position fix time duration and the GNSS validity duration from the network node in a connected mode. Process 700 may proceed from 720 to 730.

At 730, process 700 may involve processor 612 performing a GNSS measurement based on the configuration. Process 700 may proceed from 730 to 740.

At 740, process 700 may involve processor 612 transmitting, via transceiver 616, a new GNSS validity duration to the network node in the connected mode in an event that the UE completes the GNSS measurement.

In some implementations, process 700 may involve processor 612 suspending at least one of a timer and a counter for radio link monitoring in an event that the UE is performing the GNSS measurement.

In some implementations, process 700 may involve processor 612 entering the initial access, or triggering a radio link failure in an event that communication apparatus 610 is not able to transmit the new GNSS validity duration to the network node successfully.

In some implementations, process 700 may involve processor 612 receiving an UL grant from the network node. Process 700 may involve processor 612 transmitting the new GNSS validity duration through resources indicated by the UL grant.

In some implementations, before a first UL grant which is transmitted after the GNSS measurement without a RACH, process 700 may involve processor 612 setting a timing advance value (e.g., N_TA) to zero for an NPUSCH, a PUCCH, or a PUSCH. After a SIB acquisition in the connected mode, process 700 may involve processor 612 setting the timing advance value (e.g., N_TA) to zero for the NPUSCH, PUCCH, or PUSCH, and resetting an SRS.

In some implementations, in an event that a timer T317 expires during the GNSS measurement, process 700 may involve processor 612 not starting a timer T318 and a re-acquisition of a SIB31 until the GNSS measurement has been completed. In an event that the timer T317 expires during the GNSS measurement, process 700 may further involve processor 612 starting the timer T318 and the re-acquisition of the SIB31 at an expiration of the timer T317.

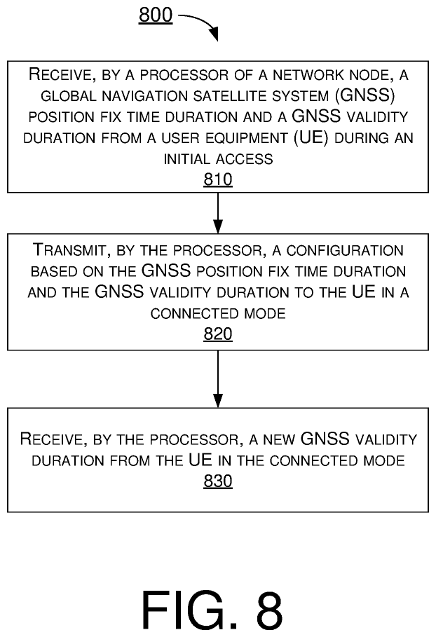

FIG. 8 illustrates an example process 800 in accordance with an implementation of the present disclosure. Process 800 may be an example implementation of above scenarios/schemes, whether partially or completely, with respect to the GNSS operations with the present disclosure. Process 800 may represent an aspect of implementation of features of network apparatus 620. Process 800 may include one or more operations, actions, or functions as illustrated by one or more of blocks 810, 820 and 830. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by network apparatus 620 or any base stations or network nodes. Solely for illustrative purposes and without limitation, process 800 is described below in the context of network apparatus 620. Process 800 may begin at block 810.

At 810, process 800 may involve processor 622 of network apparatus 620 receiving, via transceiver 626, a GNSS position fix time duration and a GNSS validity duration from a UE during the initial access. Process 800 may proceed from 810 to 820.

At 820, process 800 may involve processor 822 transmitting, via transceiver 626, a configuration based on the GNSS position fix time duration and the GNSS validity duration to the UE in a connected mode. Process 800 may proceed from 820 to 830.

At 830, process 800 may involve processor 622 receiving, via transceiver 626, a new GNSS validity duration from the UE in the connected mode.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of a user equipment (UE), a global navigation satellite system (GNSS) position fix time duration and a GNSS validity duration to a network node during an initial access;
receiving, by the processor, a configuration based on the GNSS position fix time duration and the GNSS validity duration from the network node in a connected mode;
performing, by the processor, a GNSS measurement based on the configuration; and
transmitting, by the processor, a new GNSS validity duration to the network node in the connected mode in an event that the UE completes the GNSS measurement.

2. The method of claim 1, wherein the GNSS position fix time duration and the GNSS validity duration are transmitted through a Message 5 (Msg5) message or a Message 3 (Msg3) message.

3. The method of claim 1, wherein the configuration comprises a first time duration and a second time duration, and wherein the first time duration indicates a start time of the GNSS measurement, and the second time duration indicates a measurement gap length for performing the GNSS measurement.

4. The method of claim 1, wherein the configuration comprises a first time duration and a second time duration, and wherein the first time duration indicates a start time of the GNSS measurement after an end of the GNSS validity duration, and the second time duration indicates a measurement gap length for performing the GNSS measurement.

5. The method of claim 1, wherein the configuration comprises a connected-mode discontinuous-reception (C-DRX), and wherein the GNSS measurement is autonomously performed during an inactive state of the C-DRX.

6. The method of claim 1, further comprising:
suspending, by the processor, at least one of a timer and a counter for radio link monitoring in an event that the UE is performing the GNSS measurement.

7. The method of claim 1, wherein the new GNSS validity duration is transmitted through a medium access control (MAC) control element (CE).

8. The method of claim 1, further comprising:
entering, by the processor, the initial access or triggering, by the processor, a radio link failure in an event that the UE is not able to transmit the new GNSS validity duration to the network node successfully.

9. The method of claim 1, further comprising:
receiving, by the processor, an uplink (UL) grant from the network node; and
transmitting, by the processor, the new GNSS validity duration through resources indicated by the UL grant.

10. The method of claim 1, further comprising:
before a first UL grant which is transmitted after the GNSS measurement without a random access channel (RACH), setting, by the processor, a timing advance value to zero for a narrowband physical uplink shared channel (NPUSCH), a physical uplink control channel (PUCCH), or a physical uplink shared channel (PUSCH); and
after a system information block (SIB) acquisition in the connected mode, setting, by the processor, the timing advance value to zero for the NPUSCH, PUCCH, or PUSCH, and resetting a sounding reference signal (SRS).

11. The method of claim 1, further comprising:
in an event that a timer T317 expires during the GNSS measurement, not starting a timer T318 and a re-acquisition of a system information block 31 (SIB31) until the GNSS measurement has been completed; and
in an event that the timer T317 does not expire during the GNSS measurement, starting, by the processor, the timer T318 and the re-acquisition of the SIB31 at an expiration of the timer T317.

12. An apparatus, comprising:
a transceiver which, during operation, wirelessly communicates with at least one network node; and
a processor communicatively coupled to the transceiver such that, during operation, the processor performs operations comprising:
transmitting, via the transceiver, a global navigation satellite system (GNSS) position fix time duration and a GNSS validity duration to the network node during an initial access;
receiving, via the transceiver, a configuration based on the GNSS position fix time duration and the GNSS validity duration from the network node in a connected mode;
performing a GNSS measurement based on the configuration; and
transmitting, via the transceiver, a new GNSS validity duration to the network node in the connected mode in an event that the apparatus completes the GNSS measurement.

13. The apparatus of claim 12, wherein the GNSS position fix time duration and the GNSS validity duration are transmitted through a Message 5 (Msg5) message or a Message 3 (Msg3) message.

14. The apparatus of claim 12, wherein the configuration comprises a first time duration and a second time duration, and wherein the first time duration indicates a start time of the GNSS measurement, and the second time duration indicates a measurement gap length for performing the GNSS measurement.

15. The apparatus of claim 12, wherein the configuration comprises a first time duration and a second time duration, and wherein the first time duration indicates start a time of the GNSS measurement after an end of the GNSS validity duration, and the second time duration indicates a measurement gap length for performing the GNSS measurement.

16. The apparatus of claim 12, wherein the configuration comprises a connected-mode discontinuous-reception (C-DRX), and wherein the GNSS measurement is autonomously performed during an inactive state of the C-DRX.

17. The apparatus of claim 12, wherein, during operation, the processor is further configured to perform operations comprising:
suspending at least one of a timer and a counter for radio link monitoring in an event that the apparatus is performing the GNSS measurement.

18. The apparatus of claim 12, wherein the new GNSS validity duration is transmitted to the network node through a medium access control (MAC) control element (CE).

19. A method, comprising:
receiving, by a processor of a network node, a global navigation satellite system (GNSS) position fix time duration and a GNSS validity duration from a user equipment (UE) during an initial access;
transmitting, by the processor, a configuration based on the GNSS position fix time duration and the GNSS validity duration to the UE in a connected mode; and
receiving, by the processor, a new GNSS validity duration from the UE in the connected mode.

20. The method of claim 19, wherein the configuration comprises a first time duration and a second time duration, and wherein the first time duration indicates a start time of the GNSS measurement, and the second time duration indicates a measurement gap length for performing the GNSS measurement.

21. The method of claim 19, wherein the configuration comprises a first time duration and a second time duration, and wherein the first time duration indicates a start time of the GNSS measurement after an end of the GNSS validity duration, and the second time duration indicates a measurement gap length for performing the GNSS measurement.

22. The method of claim 19, wherein the new GNSS validity duration is received through a medium access control (MAC) control element (CE).
